(19) United States
(12) Patent Application Publication
(10) Pub. No.: US 2025/0247745 A1
(43) Pub. Date: Jul. 31, 2025

(54) METHOD AND SYSTEM FOR PROVIDING A SPECIFIC CONNECTIVITY QUALITY OF SERVICE ALONG A ROUTE OF A VEHICLE

(71) Applicant: Volkswagen Aktiengesellschaft, Wolfsburg (DE)

(72) Inventors: Luca Montero Bayo, Berlin (DE); Andreas Pfadler, Berlin (DE)

(21) Appl. No.: 18/990,852

(22) Filed: Dec. 20, 2024

(30) Foreign Application Priority Data
Jan. 25, 2024 (EP) 24153945.1

(51) Int. Cl. H04W 28/18; H04W 4/40

(52) U.S. Cl. CPC H04W 28/18; H04W 4/40

(57) ABSTRACT

Technologies and techniques for providing specific connectivity quality of service along a route of a vehicle comprises, for at least one vehicle: transmitting route information and a definition of a minimum required connectivity quality of service to a service management server by user equipment of the vehicle; managing and reserving the required connectivity quality of service along the route by allocating communication resources using the service management server, which interfaces with a plurality of mobile network operators; and providing feedback to the user equipment regarding the availability of the required connectivity quality of service. The system includes a service management server and user equipment configured to execute the method. This system ensures specific connectivity quality of service, enabling advanced applications, such as remote driving, by dynamically managing resources based on vehicle routes and operator availability.

### RELATED APPLICATIONS

The present application claims priority to European Patent Application No. EP24153945.1, to Montero Bayo et al., filed Jan. 25, 2024, the contents of which is incorporated by reference in its entirety herein.

### TECHNICAL FIELD

The present disclosure relates to a method and a system for providing a specific connectivity quality of service along a route of a vehicle.

### BACKGROUND

User Equipment (UE) in mobile communications can contact a Predictive Quality of Service (PQoS) server to obtain a PQoS profile, which allows UEs to determine the availability and performance of a given service.

However, the PQoS profile received often depends on factors beyond the control of the UE, such as network load. For UEs requiring a specific level of link quality for certain services, such as tele-operated driving uplink data rates, relying solely on prediction may be insufficient to ensure the required performance, particularly when the service is critical to the application.

Certain applications, such as tele-operated driving, impose quality of service (QoS) requirements that necessitate the UE connecting to at least two mobile network operators (MNOs). This may be due to redundancy requirements or because a single MNO cannot, for example, meet the high uplink throughput demands, necessitating load balancing between multiple MNOs.

One potential solution for ensuring a certain level of link quality is 5G-enabled network slicing, which allows different services or use cases to utilize network features that are decomposed and reserved for such use. However, conventional slicing may lack the dynamism required by moving vehicles, rendering it inefficient. This inefficiency arises because the connectivity requirements of vehicles are inherently location-based, particularly when multiple MNOs are involved.

US 2020/0 221 349 A1 describes a vehicle communication system, which includes: a vehicle communication apparatus for a vehicle; a management apparatus that manages wireless resources; and a request transmitter that transmits a resource allocation request to the management apparatus for allocating location resources and wireless resources by time. The vehicle communication apparatus includes: a vehicle transmitter, a vehicle receiver, and a vehicle communication controller corresponding to a vehicle processor, which controls the vehicle transmitter and receiver. The management apparatus includes: a management apparatus receiver for receiving the resource allocation request; an allocator, corresponding to a management processor, that allocates the location resource and the wireless resource by time; and a management apparatus transmitter that transmits the allocation result of the allocator.

### SUMMARY

The present disclosure addresses the technical problem of providing a solution for ensuring specific connectivity quality of service along a route of a vehicle. According to the present disclosure, this technical problem is resolved by the subject matter of the independent claims. Additional advantages and features are described in the dependent claims.

For example, a method is provided for ensuring specific connectivity quality of service along a route of a vehicle, comprising, for at least one vehicle:
transmitting route information and a definition of a minimum required connectivity quality of service along the route to a service management server by a user equipment of the vehicle;
managing and reserving the required connectivity quality of service along the route of the vehicle by allocating communication resources along the route using the service management server, the service management server being configured to allocate communication resources from a plurality of mobile network operators by interfacing and communicating with these mobile network operators;
providing and transmitting feedback information to the user equipment regarding the availability of the required connectivity quality of service along the route.

Additionally, a system is provided for ensuring specific connectivity quality of service along a route of a vehicle. The system comprises a service management server and at least one user equipment associated with a corresponding vehicle. The at least one user equipment is configured to transmit route information and a definition of a minimum required connectivity quality of service along the route to the service management server. The service management server is configured to manage and reserve the required connectivity quality of service along the vehicle's route by allocating communication resources along the route. The service management server is further configured to allocate communication resources from a plurality of mobile network operators by interfacing and communicating with these operators, and to provide and transmit feedback information to the at least one user equipment regarding the availability of the required connectivity quality of service along the route.

The method and system disclosed herein enable the provision of specific connectivity quality of service along a vehicle's route, facilitating advanced applications such as remote (i.e., tele-operated) driving by an automated or human driver. A key aspect of this approach is that the vehicle's route is known beforehand, allowing the required communication services to be managed and allocated accordingly. Another significant aspect is the centralized management and allocation of communication resources from multiple, and potentially all, mobile network operators within a given region via the service management server.

To exploit information about the vehicle's route, the user equipment of the vehicle transmits route information and a definition of the minimum required connectivity quality of service along the route to the service management server. The user equipment may be, for example, a navigation device or a control device of the vehicle. Alternatively, the user equipment could be a mobile device, such as a tablet computer or a smartphone.

Additional features and embodiments of the system correspond to those described for the method, with the advantages being analogous in each case.

### BRIEF DESCRIPTION OF THE DRAWINGS

The present disclosure is explained in greater detail below using preferred exemplary embodiments with reference to the drawings. In the drawings:

FIG. 1 shows a schematic of an example of the system for providing a specific connectivity quality of service along a route of a vehicle, according to some aspects of the present disclosure; and

FIG. 2 shows a schematic diagram of an example of the method for providing a specific connectivity quality of service along a route of a vehicle, according to some aspects of the present disclosure.

### DETAILED DESCRIPTION

In some examples, a service management server receives transmitted route information and a definition from the user equipment. For example, the service management server receives the route information and definitions from a plurality of vehicles, each requesting a specific connectivity quality of service along respective routes. The service management server manages and reserves the required connectivity quality of service along the vehicle's route by allocating communication resources accordingly. For this purpose, the service management server is configured to allocate communication resources from a plurality of mobile network operators (MNOs) by interfacing and communicating with these operators. Specifically, the service management server allocates individual communication resources of the mobile network operators. If sufficient communication resources are unavailable, the allocation may be performed on a first-come-first-served basis or distributed more equitably by reducing available resources for all requests. Optimization methods may also be employed to optimize resource allocation and distribution across multiple vehicles.

After allocating communication resources for a vehicle, the service management server provides and transmits feedback information to the user equipment regarding the availability of the required connectivity quality of service along the route. If the reservation is successful—meaning the requested connectivity quality of service can be provided—the feedback includes positive confirmation. Conversely, if the reservation is unsuccessful, the feedback comprises negative confirmation.

Portions of the system, such as the user equipment and/or the service management server, can be implemented individually or collectively as a combination of hardware and software, such as program code executed on a microcontroller or microprocessor. Alternatively, these components may be implemented individually or collectively as an application-specific integrated circuit (ASIC) and/or field-programmable gate array (FPGA). The service management server typically includes at least one processing device (e.g., a microprocessor), at least one memory, and at least one communication interface. Similarly, each user equipment typically includes at least one processing device, at least one memory, and at least one communication interface.

The communication resources may include, for example, 2G, 3G, LTE, LTE+ (4G), 5G, WLAN, Wi-Fi, or satellite communication. These resources may be allocated in the form of time slots within a defined region or area.

In some examples, route information includes the vehicle's route as a set of waypoints and the arrival times at each waypoint. This enables the service management server to allocate communication resources precisely to regions corresponding to the waypoints at the respective arrival times. Greater precision in the route information allows for more accurate allocation of communication resources.

In some examples, route information also includes a tolerance margin around the arrival time at each waypoint. The service management server allocates communication resources with consideration for these tolerance margins, allowing for a time window around the arrival time to accommodate deviations due to traffic or other factors. For example, the margin may span seconds or minutes, such as +/−1 minute.

In some examples, the definition of the minimum required connectivity quality of service includes one or more attributes such as link quality of service, a dedicated network slice, or redundancy requirements. This facilitates the precise definition of technological requirements necessary to support specific applications or services in the vehicle. Link quality of service attributes may include latency, reliability, and throughput requirements, while redundancy requirements may include multi-radio access technology (RAT), multi-MNO, or physically independent radio path requirements.

In some examples, applications or services in the vehicle are locked or unlocked for a route based on feedback information. This ensures that only applications or services with the requested connectivity quality of service are made available. Applications or services that cannot meet these requirements remain locked to enhance reliability. For example, if the requested connectivity quality of service is confirmed, a remote driving application may be unlocked for the route. Conversely, if the requested connectivity quality of service is unavailable, the remote driving application may remain locked.

In some examples, the vehicle transmits priority information to the service management server, and the allocation of communication resources is carried out considering this priority information. Priority information enables the ranking of requests from multiple vehicles, ensuring the allocation of limited resources to higher-priority vehicles.

In some examples, priority information includes vehicle operating mode information. This allows the allocation process to account for the current state of the vehicle. For instance, a vehicle operating in remote guidance mode, requiring vital connectivity for safe operation, may be assigned the highest priority. Similarly, a vehicle operating in an automated mode that experiences a component failure may receive higher priority to ensure continued operation via a remote replacement component. Priority modes may include normal operating mode (low or medium priority), remote operation mode (highest priority), and emergency or failure mode (highest priority).

In some examples, priority information includes vehicle class information, which considers the vehicle type. For instance, ambulances, fire trucks, or police cars may be assigned higher priority when on duty to ensure reliable connectivity.

In some examples, feedback information includes identifiers for upcoming handovers or physical layer configurations necessary to achieve the required connectivity quality of service. This allows the user equipment to adapt and configure on the vehicle side, ensuring uninterrupted service along the route.

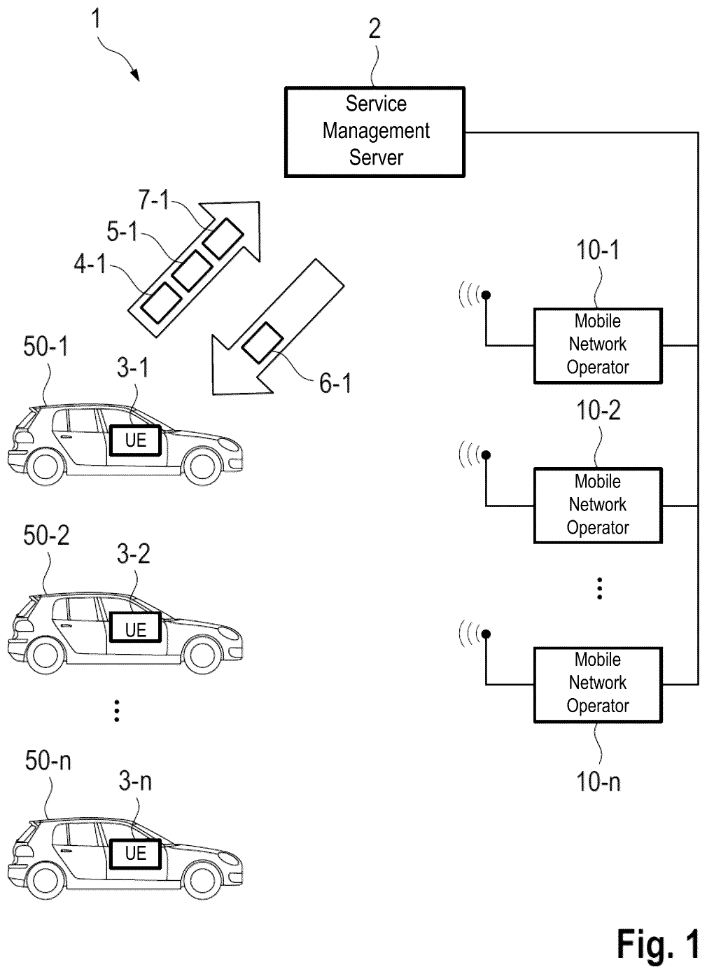

FIG. 1 illustrates a schematic of an example of a system 1 for providing specific connectivity quality of service along a route of a vehicle 50-x, according to some aspects of the present disclosure. The system 1 is configured to execute the method described in this disclosure.

The system 1 comprises a service management server 2 and at least one user equipment 3-x associated with a corresponding vehicle 50-x. The user equipment 3-x may form part of other devices within the vehicle 50-x.

The user equipment 3-x includes at least one processing device (not shown) and at least one memory (not shown), wherein the processing device is configured to execute operations necessary to perform at least part of the method tasks. Additionally, the user equipment 3-x comprises a communication interface (not shown) for communication with the service management server 2 and base stations of mobile network operators 10-x during regular operation.

The user equipment 3-x is configured to transmit route information 4-x and a definition 5-x of a minimum required connectivity quality of service along the route to the service management server 2.

The service management server 2 includes at least one processing device (not shown) and at least one memory (not shown), wherein the processing device is configured to execute operations necessary to perform at least part of the method tasks. Furthermore, the service management server 2 includes a communication interface (not shown) for communication with the user equipment 3-x and the mobile network operators 10-x.

The system 1 may further include mobile network operators 10-x.

The service management server 2 is configured to manage and reserve the required connectivity quality of service along the vehicle's route by allocating communication resources accordingly. Specifically, the service management server 2 is configured to allocate communication resources from multiple mobile network operators 10-x by interfacing and communicating with them. Upon successful allocation, the mobile network operators 10-x provide the required connectivity quality of service along the route at the designated times.

Additionally, the service management server 2 is configured to provide and transmit feedback information 6-x to the user equipment 3-x regarding the availability of the required connectivity quality of service along the route.

The route information 4-x may include the route to be followed by the vehicle 50-x as a series of waypoints, along with the arrival times at each waypoint.

The route information 4-x may also include a tolerance margin around the arrival time at each waypoint. Alternatively, a tolerance margin may be assigned to the arrival time at each waypoint, wherein the service management server 2 allocates communication resources in consideration of these tolerance margins. The tolerance margin may span seconds or minutes, for example, +/−1 minute.

The definition 5-x of the minimum required connectivity quality of service may include one or more attributes such as a link quality of service, a dedicated network slice, or redundancy requirements.

An application and/or service of the vehicle 50-x may be locked or unlocked for the route by the user equipment 3-x based on the feedback information 6-x.

The vehicle 50-x may also transmit priority information 7-x to the service management server 2, wherein the allocation of communication resources considers this priority information. Vehicles 50-x with higher priority may be given precedence during resource allocation.

The priority information 7-x may include details such as vehicle operating mode information or vehicle class information.

The feedback information 6-x may include identifiers for upcoming handovers or physical layer configurations required to achieve the necessary connectivity quality of service. The user equipment 3-x utilizes these identifiers to handle handovers between different base stations of the mobile network operators 10-x and implements the physical layer configurations at its communication interface.

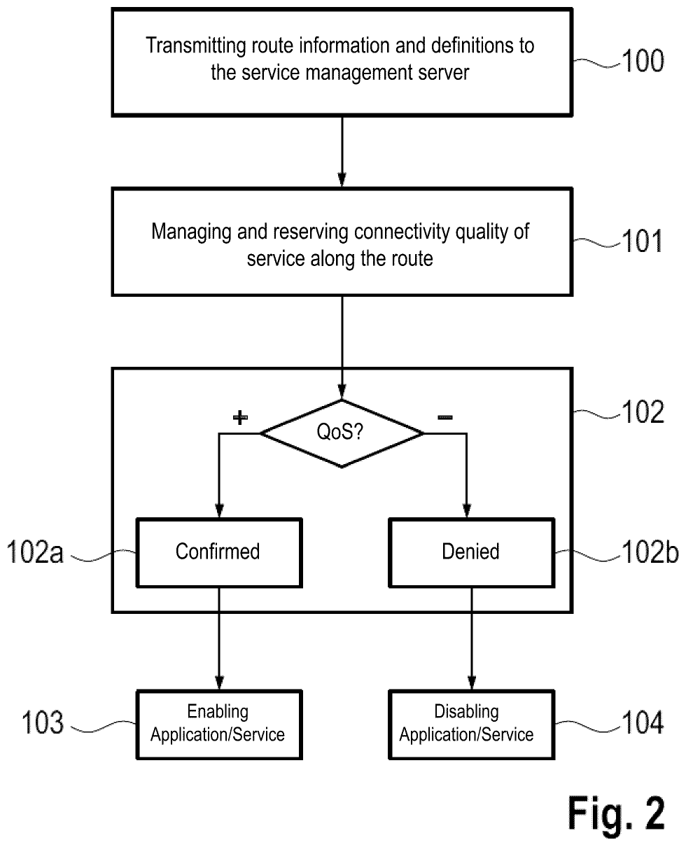

FIG. 2 depicts a schematic diagram of an example of the method for providing specific connectivity quality of service along a route of a vehicle, according to some aspects of the present disclosure.

In task 100, route information and a definition of a minimum required connectivity quality of service along the route are transmitted to a service management server by the user equipment of the vehicle. Prior to this, the user equipment may gather the route information and definition from a navigation device or control device of the vehicle. The request for specific connectivity quality of service may be triggered, for example, by the navigation device or control device after a user specifies a destination, and the navigation device determines the route to the destination.

The route information may include the route as a series of waypoints and the arrival times at each waypoint. Additionally, the route information may include tolerance margins around the arrival times at each waypoint, enabling the service management server to allocate communication resources considering these margins.

The definition of the minimum required connectivity quality of service may include attributes such as link quality of service, a dedicated network slice, or redundancy requirements.

In task 101, the service management server manages and reserves the required connectivity quality of service along the vehicle's route by allocating communication resources. To achieve this, the service management server communicates with multiple mobile network operators through its communication interface. The allocation process may involve determining the closest available base station of a mobile network operator to each waypoint along the route and attempting to reserve the necessary communication services at those base stations. If one operator cannot fulfill the resource requirements, the service management server may attempt to reserve resources from another operator capable of providing them at the respective waypoint.

In task 102, the service management server provides and transmits feedback information to the user equipment regarding the availability of the required connectivity quality of service. If the quality of service can be provided along the route, a positive feedback is transmitted to the user equipment in task 102a. Otherwise, a negative feedback is transmitted in task 102b.

Following the feedback, the user equipment may lock or unlock an application and/or service of the vehicle based on the feedback. For positive feedback, the application or service is unlocked in task 103. For negative feedback, the application or service is locked (or remains locked) in task 104.

Additional embodiments of the method are described in relation to the system.

### LIST OF REFERENCE NUMERALS

1 system
2 service management server
3-x user equipment
4-x route information
5-x definition of a minimum required connectivity QoS
6-x feedback information
7-x priority information
10-x mobile network operator (MNO)
50-x vehicle
100-104 tasks of the method

1. A method for providing a specific connectivity quality of service along a route of a vehicle, comprising:
receiving, by a service management server, from a user equipment (UE) of the vehicle, route information and a definition of a minimum required connectivity quality of service along the route;
managing and reserving, by the service management server, the required connectivity quality of service along the route of the vehicle by allocating communication resources, wherein the service management server interfaces and communicates with a plurality of mobile network operators to allocate communication resources: (i) specific to regions along the route, and/or (ii) based on the route information, comprising at least one of arrival times, tolerance margins, or priority information transmitted by the vehicle; and
transmitting, by the service management server, feedback information to the UE regarding the availability of the required connectivity quality of service along the route, wherein the feedback information comprises at least one of a confirmation of resource availability or configuration details for achieving the required connectivity quality of service.

2. The method of claim 1, wherein the route information comprises the route to be followed by the vehicle as a set of waypoints and the arrival time at which the vehicle will be at each waypoint.

3. The method of claim 2, wherein the route information further comprises a tolerance margin around the arrival time at each waypoint, and/or a tolerance margin is assigned to the arrival time at each waypoint, wherein the service management server allocates the communication resources based on the tolerance margins.

4. The method of claim 1, wherein the definition of the minimum required connectivity quality of service comprises at least one of: latency, reliability, or throughput requirements.

5. The method of claim 1, further comprising determining, by the service management server, based on the feedback information, whether to enable or disable an application or service associated with the vehicle.

6. The method of claim 1, further comprising receiving, by the service management server, priority information from the vehicle, wherein the allocation of communication resources is based on the priority information.

7. The method of claim 6, wherein the priority information comprises vehicle operating mode information.

8. The method of claim 6, wherein the priority information comprises vehicle class information.

9. The method of claim 1, wherein the feedback information comprises at least one of: identifiers to proceed with upcoming handovers or physical layer configurations necessary to achieve the required connectivity quality of service.

10. A system for providing a specific connectivity quality of service along a route of a vehicle, comprising:
a communication interface, communicatively coupled to a network; and
a service management server, operatively coupled to the communication interface, the service management server being configured to:
receive, via the communication interface, route information and a definition of a minimum required connectivity quality of service along the route from a user equipment (UE) of the vehicle, wherein the definition comprises at least one of latency, reliability, or throughput requirements;
manage and reserve the required connectivity quality of service along the route of the vehicle by allocating communication resources, wherein the service management server interfaces and communicates, via the communication interface, with a plurality of mobile network operators to allocate communication resources: (i) specific to regions along the route, and/or (ii) based on the route information, comprising at least one of arrival times, tolerance margins, or priority information transmitted by the vehicle; and
transmit, via the communication interface, feedback information to the UE regarding the availability of the required connectivity quality of service along the route, wherein the feedback information comprises at least one of a confirmation of resource availability or configuration details for achieving the required connectivity quality of service.

11. The system of claim 10, wherein the route information comprises the route to be followed by the vehicle as a set of waypoints and the arrival time at which the vehicle will be at each waypoint.

12. The system of claim 11, wherein the route information further comprises a tolerance margin around the arrival time at each waypoint, and/or a tolerance margin is assigned to the arrival time at each waypoint, wherein the service management server is configured to allocate the communication resources based on the tolerance margins.

13. The system of claim 10, wherein the definition of the minimum required connectivity quality of service comprises at least one of latency, reliability, or throughput requirements.

14. The system of claim 10, wherein the service management server is further configured to determine, based on the feedback information, whether to enable or disable an application or service associated with the vehicle.

15. The system of claim 10, wherein the service management server is further configured to receive, via the communication interface, priority information from the vehicle, wherein the allocation of communication resources is based on the priority information.

16. The system of claim 15, wherein the priority information comprises vehicle operating mode information.

17. The system of claim 15, wherein the priority information comprises vehicle class information.

18. The system of claim 10, wherein the feedback information comprises at least one of identifiers to proceed with upcoming handovers or physical layer configurations necessary to achieve the required connectivity quality of service.

19. A system for providing a specific connectivity quality of service along a route of a vehicle, comprising:
a communication interface, communicatively coupled to a network; and
a service management server, operatively coupled to the communication interface, the service management server being configured to:
receive, via the communication interface, route information and a definition of a minimum required connectivity quality of service along the route from user equipment (UE) of the vehicle, wherein the route information includes a plurality of waypoints along the route and corresponding arrival times, and the definition comprises at least one of latency, reliability, or throughput requirements;
manage and reserve the required connectivity quality of service along the route of the vehicle by allocating communication resources, wherein the service management server interfaces and communicates, via the communication interface, with a plurality of mobile network operators to allocate communication resources (i) specific to regions corresponding to the waypoints along the route, and (ii) accounting for potential deviations in arrival times; and
transmit, via the communication interface, feedback information to the UE regarding the availability of the required connectivity quality of service along the route, wherein the feedback information comprises at least one of a confirmation of resource availability, handover identifiers, or configuration details for achieving the required connectivity quality of service.

20. The system of claim 19, wherein the service management server is further configured to allocate communication resources based on a tolerance margin around the arrival time at each waypoint, wherein the tolerance margin spans a time window of at least one minute in both directions relative to the arrival time.
